(19) United States
(12) Patent Application Publication
(10) Pub. No.: US 2024/0319138 A1
(43) Pub. Date: Sep. 26, 2024

(54) TANDEM DIFFERENTIAL MOBILITY ION MOBILITY SPECTROMETRY

(71) Applicant: Hamilton Sundstrand Corporation, Charlotte, NC (US)

(72) Inventors: Ben D. Gardner, Colton, CA (US); Gary A. Eiceman, Las Cruces, NM (US); Peter Fowler, Las Cruces, NM (US)

(73) Assignee: Hamilton Sundstrand Corporation, Charlotte, NC (US)

(21) Appl. No.: 18/419,336

(22) Filed: Jan. 22, 2024

Related U.S. Application Data
(60) Provisional application No. 63/440,454, filed on Jan. 23, 2023.

(51) Int. Cl. G01N 27/624; G01N 27/64; G01N 27/68; H01J 49/00

(52) U.S. Cl. CPC G01N 27/624; G01N 27/64; G01N 27/68; H01J 49/0068

(57) ABSTRACT

In accordance with at least one aspect of this disclosure, a method for identifying a chemical composition includes, collecting a chemical sample and introducing the chemical sample to a detection system, performing, with a differential mobility spectrometer, differential mobility spectrometry on the chemical sample to separate ions within the chemical sample into a first constituent group based on a first analysis characteristic. The method further includes, performing, with an ion mobility spectrometer, ion mobility spectrometry on the first constituent group to separate ions within the first constituent group into a second constituent group based on a second analysis characteristic, and determining an identity of the chemical sample based on ions present within the second constituent group.

### CROSS-REFERENCE TO RELATED APPLICATIONS

This application claims priority to and the benefit of U.S. Provisional Application No. 63/440,454, filed Jan. 23, 2023, the entire contents of which are herein incorporated by reference in their entirety.

### TECHNICAL FIELD

The present disclosure relates to differential mobility and ion mobility spectrometry, e.g., for chemical detection.

### BACKGROUND

Mobility spectrometry is a means for determining a chemical identity of an analyte. In the field of remote, unattended chemical sensing, the conventional techniques have been considered satisfactory for their intended purpose. However, there is an ever-present need for improved systems and methods for chemical detection that provides higher accuracy with respect to identifying more constituents of the sample, while at the same time providing higher resolution results as compared to prior system. This disclosure provides a solution for this need.

### SUMMARY

In accordance with at least one aspect of this disclosure, a method for identifying a chemical composition includes, collecting a chemical sample and introducing the chemical sample to a detection system, performing, with a differential mobility spectrometer, differential mobility spectrometry on the chemical sample to separate ions within the chemical sample into a first constituent group based on a first analysis characteristic. Performing differential mobility spectrometry on the chemical sample further comprises, filtering the ions within the ionized flow such that only ions having a desired mobility pass to a fragmenter, and fragmenting the filtered sample to further dissociate ions within the filtered sample to generate additional ion types having distinctive mobility characteristics. The method further includes, performing, with an ion mobility spectrometer, ion mobility spectrometry on the first constituent group to separate ions within the first constituent group into a second constituent group based on a second analysis characteristic, and determining an identity of the chemical sample based on ions present within the second constituent group.

The method can further include, ionizing the chemical sample using an ionization source to produce an ionized flow prior to performing differential mobility spectrometry on the chemical sample.

Performing differential mobility spectrometry on the chemical sample can further include, subjecting the ionized flow to a first radio frequency field to cause ions within the ionized flow to oscillate, and applying a first voltage differential across the first radio frequency field to cause positive ions within the ionized flow to drift towards a negative charge and negative ions to drift towards a positive charge to separate the positive ions from the negative ions within the ionized flow.

In certain embodiments, performing differential mobility spectrometry on the chemical sample further includes, filtering the ions within the fragmented ionized flow to generate the first constituent group such that only the first constituent group passes to an ion mobility spectrometer of the detection system. Applying the first voltage differential can include, progressively modifying the first voltage differential to allow selected ions within the ionized flow and/or the fragmented ionized flow to pass into the ion mobility spectrometer as the first constituent group. The method can include, generating a first data set for the first constituent group based on the first analysis characteristic.

In certain embodiments, performing differential mobility spectrometry on the chemical sample further includes, applying a second voltage differential across a second radio frequency field to cause positive ions within the fragmented ionized flow to drift towards a negative charge and negative ions to drift towards a positive charge to separate the positive ions from the negative ions within the fragmented ionized flow. In certain such embodiments, differential mobility spectrometry can further include filtering the ions within the fragmented ionized flow to generate the first constituent group such that only the first constituent group passes to an ion mobility spectrometer.

Applying the first voltage differential and/or applying the second voltage differential further includes, progressively modifying the first voltage differential and/or the second voltage differential to allow selected ions within the ionized flow and/or the fragmented ionized flow to pass into the ion mobility spectrometer as the first constituent group, and wherein performing differential mobility spectrometry further comprises, generating a first data set for the first constituent group based on the first analysis characteristic.

Performing ion mobility spectrometry on the first constituent group can further include, passing the ionized flow containing only the first constituent group to an analytical module the ion mobility spectrometer, and applying a voltage differential across the analytical module to draw positive ions with in the first constituent group to a negative charge of a first analytical module of the ion mobility spectrometer and draw the negative ions within the first constituent group to a positive charge of a second analytical module of the ion mobility spectrometer.

Performing ion mobility spectrometry on the first constituent group can further include, separating the ions of first constituent group in space and performing a first time of flight analysis on the ions within the first constituent group to allow selected ions within the first constituent group to pass to a fragmenter, and fragmenting the selected ions within the first constituent group to further dissociate and generate additional ion types having distinctive mobility characteristics generating a fragmented flow of ions forming the second constituent group.

Performing ion mobility spectrometry on the first constituent group can further include, performing a second time of flight analysis on the fragmented flow of ions within second constituent group to generate a second data set for the second constituent group based on the second analysis characteristic, correlating the second dataset generated for the second constituent group with the first dataset generated for the first constituent group; and, determining the identity of the chemical composition based on the correlation between the first dataset and the second data set.

In accordance with at least on aspect of this disclosure, a system, can include, a chemical detector including a chemical analyte inlet, an ionization module having an ionization source therein fluidly connected to the chemical analyte inlet configured to receive the chemical analyte and ionize the chemical analyte to generate an ionized flow, and an analytical module fluidly connected to the ionization module to receive the ionized flow and configured to determine a chemical identity of the chemical analyte.

The analytical module can include, a differential mobility spectrometer fluidly connected to the chemical analyte inlet and the analytical module can also include an ion mobility spectrometer fluidly connected to the differential mobility spectrometer.

The differential mobility spectrometer can further include, a first set of electrodes including a first positively charged electrode and a first negatively charged electrode configured to separate positive ions from negative ions within the ionized flow and wherein only ions of a predetermined mobility characteristic flow past the first set of electrodes; and a fragmenter downstream of the first set of electrodes configured to fragment the filtered sample to further dissociate ions within the filtered sample to generate a fragmented ionized flow with additional ion types having distinctive mobility characteristics

The ionization source can be configured to ionize the chemical analyte flowing through ionization region. In certain embodiments, the ionization source can include any one or more of an electric-field ionizer, a radioactive ionizer, or a photo-ionizer.

In certain embodiments, an outlet of the fragmenter can be an outlet of the differential mobility spectrometer such that the fragmented ionized flow forms a first constituent group and passes to the ion mobility spectrometer.

In certain embodiments, the differential mobility spectrometer can include a second set of electrodes including a second positively charged electrode and a second negatively charged electrode downstream of the fragmenter configured to separate positive ions from negative ions within the fragmented ionized flow and ions of a predetermined mobility flow past the second set of electrodes forming a first constituent group, where the first constituent group passes to the ion mobility spectrometer.

In certain embodiments, the differential mobility spectrometer can include a computational module configured to generate a first data set for the first constituent group based on a first analysis characteristic.

In certain embodiments, the ion mobility spectrometer can include a first positive ion drift tube and a first negative ion drift tube each fluidly connected to an outlet of the differential mobility spectrometer, wherein the first positive ion drift tube is configured to receive positive ions from the first constituent group and the first negative ion drift tube configured to receive negative ions from the first constituent group.

The ion mobility spectrometer can further include a first shutter at an inlet of the first positive ion drift tube configured to filter the first constituent group entering the first positive ion drift tube based on ion mobility and a second shutter at an inlet of the first negative ion drift tube configured to filter the first constituent group entering the first negative ion drift tube based on ion mobility, wherein the first and second shutter provide selected ions from the first constituent group to the first positive ion drift tube and the first negative ion drift tube.

The ion mobility spectrometer can also include a first fragmenter disposed at an outlet of the first positive ion drift tube and a second fragmenter disposed at an outlet of the first negative ion drift tube configured to fragment the selected ions from the first constituent group to further dissociate the selected ions from the first constituent group to generate the second constituent group with additional ion types having distinctive mobility characteristics.

The ion mobility spectrometer can further include, a positive ion detector at an end of the second positive ion drift tube configured to draw the positive ions towards the positive ion detector and configured to detect a time of flight of the positive ions of the second constituent group within the second positive ion drift tube and a negative ion detector at an end of the second negative ion drift tube configured to draw the negative ions towards the negative ion detector and configured to detect a time of flight of the negative ions of the second constituent group within the second negative ion drift tube.

In certain embodiments, the ion mobility spectrometer can be two ion mobility spectrometers connected in series.

The analytical module can be configured to determine a drift time of the positive ions of the second constituent group within the second positive ion drift tube and a drift time of the negative ions of the second constituent group in the second negative ion drift tube and generate a second data set for the second constituent group based on the second analysis characteristic.

The analytical module can include a computational module configured to correlate the second dataset generated for the second constituent group with the first dataset generated for the first constituent group; and determine the identity of the chemical analyte based on the correlation between the first dataset and the second data set.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, other embodiments thereof will be described in detail herein below with reference to certain figures, wherein:

FIG. 1 is a schematic diagram of a system in accordance with this disclosure, showing a chemical detection system;

FIG. 2 is an enlarged schematic view of a differential mobility spectrometer of the chemical detection system of FIG. 1;

FIG. 3 is an enlarged schematic view of a portion of an ion mobility spectrometer of the chemical detection system of FIG. 1;

FIG. 4A is an example dataset identifying a chemical composition of an example analyte analyzed in the chemical detector of FIG. 1;

FIG. 4B is an example of a dataset generated after analysis with the ion mobility spectrometer of FIG. 3; and

FIG. 4C is an example of a dataset generated after analysis with the differential mobility spectrometer of FIG. 2.

### DETAILED DESCRIPTION

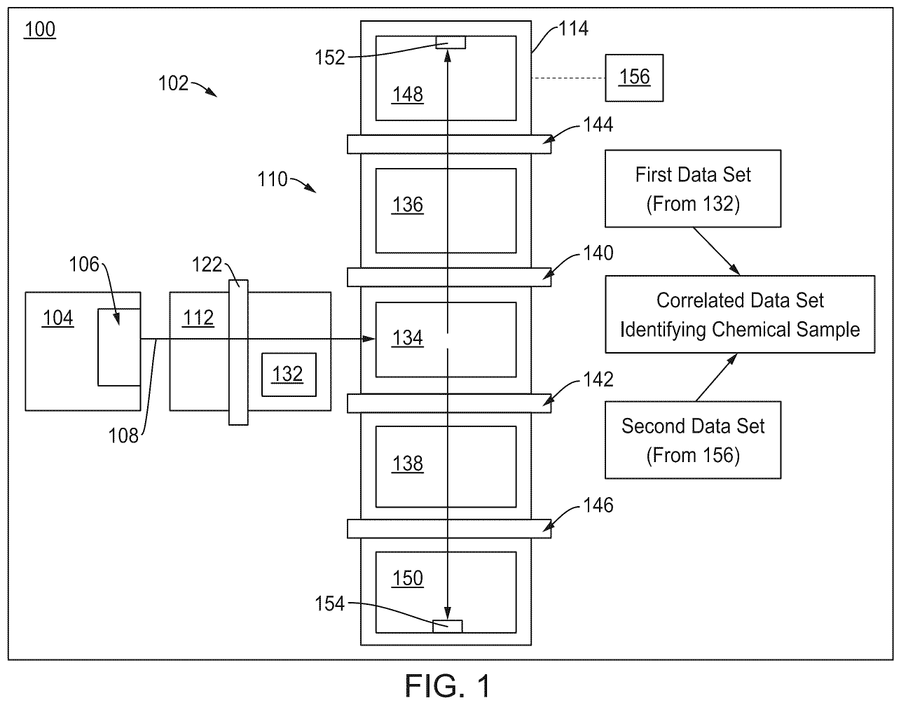

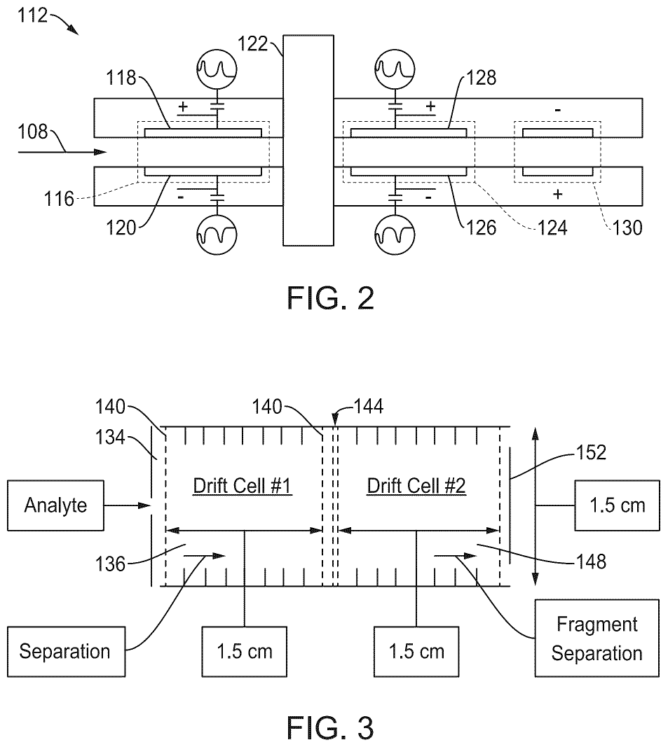

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-4.

In accordance with at least on aspect of this disclosure, as shown in FIG. 1, a system 100 can include, a chemical detector 102 including a chemical analyte inlet 104, an ionization module 106 having an ionization source 107 therein fluidly connected to the chemical analyte inlet configured to receive a chemical analyte and ionize the chemical analyte to generate an ionized flow 108, an analytical module 110 fluidly connected to the ionization module 106 to receive the ionized flow 108 and configured to determine a chemical identity of the chemical analyte. The ionization source 107 can be configured to ionize the chemical analyte flowing through ionization region 106. In certain embodiments, the ionization source 107 can include any one or more of an electric-field ionizer, a radioactive ionizer, or a photo-ionizer.

The analytical module 110 can include, a differential mobility spectrometer 112 fluidly connected to the chemical analyte inlet 104 and the analytical module 110 can also include an ion mobility spectrometer 114 fluidly connected to the differential mobility spectrometer 112.

As shown in FIGS. 1 and 2, the differential mobility spectrometer 112 can further include, a first set of electrodes 116 including a first positively charged electrode 118 and a first negatively charged electrode 120 configured to separate positive ions from negative ions within the ionized flow and wherein only ions of a predetermined mobility characteristic flow past the first set of electrodes 116 (e.g., charged plates). A fragmenter 122 can be included downstream of the first set of electrodes 116 configured to fragment the filtered sample to further dissociate ions within the filtered sample to generate a fragmented ionized flow with additional ion types having distinctive mobility characteristics.

In certain embodiments, an outlet of the fragmenter can be an outlet of the differential mobility spectrometer 112 such that the fragmented ionized flow forms a first constituent group and passes to the ion mobility spectrometer 114.

In certain embodiments, as shown, the differential mobility spectrometer 112 can include a second set of electrodes 124 (e.g., charged plates) including a second positively charged electrode 126 and a second negatively charged electrode 128 downstream of the fragmenter 122 configured to separate positive ions from negative ions within the fragmented ionized flow and ions of a predetermined mobility flow past the second set of electrodes forming a first constituent group. The first constituent group passes to a detector 130 of the differential mobility spectrometer 112, then the first constituent group passes to the ion mobility spectrometer 114.

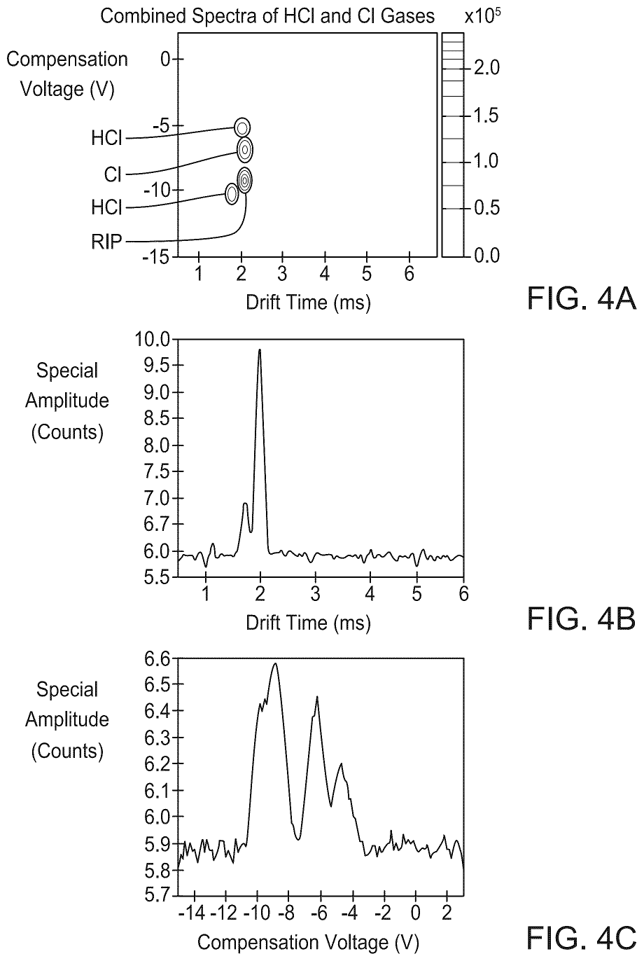

As shown, the differential mobility spectrometer can include a computational module 132 configured to generate a first data set for the first constituent group based on a first analysis characteristic (e.g., a mobility constant which can be determined considering one or more of the following variables for each ion: size, mass, shape, and the ions respective response to atomsphere). An example of the first dataset can be seen in FIG. 4C.

With reference now to FIGS. 1 and 3, the ion mobility spectrometer 114 can include a source region 134 configured to receive the first constituent group from the differential mobility spectrometer 112. The ion mobility spectrometer includes first positive ion drift tube 136 and a first negative ion drift tube 138 each fluidly connected to an outlet of the differential mobility spectrometer 112 though the source region 134, wherein the first positive ion drift tube 136 is configured to receive positive ions from the first constituent group and the first negative ion drift tube 138 is configured to receive negative ions from the first constituent group.

The ion mobility spectrometer 114 can further include a first shutter 140 at an inlet of the first positive ion drift tube 136 configured to filter the first constituent group entering the first positive ion drift tube 136 based on ion mobility and a second shutter 142 at an inlet of the first negative ion drift tube 138 configured to filter the first constituent group entering the first negative ion drift tube based on ion mobility, wherein the first and second shutter provide selected ions from the first constituent group to the first positive ion drift tube 136 and the first negative ion drift tube 138.

The ion mobility spectrometer 114 can also include a first fragmenter 144 disposed at an outlet of the first positive ion drift tube 136 and a second fragmenter 146 disposed at an outlet of the first negative ion drift tube 138 configured to fragment the selected ions from the first constituent group to further dissociate the selected ions from the first constituent group to generate the second constituent group with additional ion types having distinctive mobility characteristics.

A second positive ion drift tube 148 is fluidly connected to receive fragmented ions from first fragmenter 144 and a second negative ion drift tube 150 is fluidly connected to receive fragmented ions from the second fragmenter 146. The ion mobility spectrometer 114 can further include, a positive ion detector 152 at an end of the second positive ion drift tube 148 configured to draw the positive ions towards the positive ion detector and configured to detect a time of flight of the positive ions of the second constituent group within the second positive ion drift tube 148. A negative ion detector 154 can be included at an end of the second negative ion drift tube 150 configured to draw the negative ions towards the negative ion detector 154 and configured to detect a time of flight of the negative ions of the second constituent group within the second negative ion drift tube. The ion mobility spectrometer 114 can be configured to function similar to two ion mobility spectrometers connected in series, which is shown schematically in FIG. 3 for just the positive drift.

The analytical module 102 can be configured to determine a drift time of the positive ions of the second constituent group within the second positive ion drift tube 148 and a drift time of the negative ions of the second constituent group in the second negative ion drive tube 150 and generate a second data set for the second constituent group based on the second analysis characteristic (e.g., time of flight of the fragmented ions within the second constituent group). An example of the second dataset can be seen in FIG. 4B.

The analytical module 102 can include a computational module 156 configured to correlate the second dataset generated for the second constituent group with the first dataset generated for the first constituent group, and determine the identity of the chemical analyte based on the correlation between the first dataset and the second data set. An example of the combined and correlated datasets is shown in FIG. 4A.

In accordance with at least one aspect of this disclosure, a method for identifying a chemical composition, for example using the system 100, can include, collecting a chemical sample and introducing the chemical sample to a detection system (e.g., system 100). The method can further include, ionizing the chemical sample using an ionization source (e.g., module 106 and source 107) to produce an ionized flow (e.g., flow 108) prior to performing differential mobility spectrometry on the chemical sample.

The method can include, performing, with a differential mobility spectrometer (e.g., spectrometer 112), differential mobility spectrometry on the chemical sample to separate ions within the chemical sample into a first constituent group based on a first analysis characteristic. The method further includes, performing, with an ion mobility spectrometer (e.g., spectrometer 114), ion mobility spectrometry on the first constituent group to separate ions within the first constituent group into a second constituent group based on a second analysis characteristic. The method can include determining an identity of the chemical sample based on ions present within the second constituent group.

Performing differential mobility spectrometry on the chemical sample can further include, subjecting the ionized flow to a first radio frequency (RF) field to cause ions within the ionized flow to oscillate, and applying a first voltage differential across the first radio frequency field to cause positive ions within the ionized flow to drift towards a negative charge and negative ions to drift towards a positive charge to separate the positive ions from the negative ions within the ionized flow.

Performing differential mobility spectrometry on the chemical sample can include filtering the ions within the ionized flow such that only ions having a desired mobility pass to a fragmenter (e.g., fragmenter 122). The method can further include fragmenting the filtered sample to further dissociate ions within the filtered sample to generate additional ion types having distinctive mobility characteristics, and filtering the ions within the fragmented ionized flow to generate the first constituent group such that only the first constituent group passes to an ion mobility spectrometer of the detection system. In certain embodiments, fragmenting can be accomplished by applying an RF field (different from the first RF field) to the ions within the fragmenter.

In certain embodiments, applying the first voltage differential can include, progressively modifying the first voltage differential to allow selected ions within the ionized flow and/or the fragmented ionized flow to pass into the ion mobility spectrometer as the first constituent group. The method can include, generating a first data set for the first constituent group based on the first analysis characteristic (e.g., as shown in FIG. 4C).

In certain embodiments, performing differential mobility spectrometry on the chemical sample further includes, applying a second voltage differential across a second radio frequency field to cause positive ions within the fragmented ionized flow to drift towards a negative charge and negative ions to drift towards a positive charge to separate the positive ions from the negative ions within the fragmented ionized flow. In certain such embodiments, differential mobility spectrometry can further include filtering the ions within the fragmented ionized flow to generate the first constituent group such that only the first constituent group passes to an ion mobility spectrometer.

Applying the first voltage differential and/or applying the second voltage differential can include progressively modifying the first voltage differential and/or the second voltage differential to allow selected ions within the ionized flow and/or the fragmented ionized flow to pass into the ion mobility spectrometer as the first constituent group, and wherein performing differential mobility spectrometry further comprises, generating a first data set for the first constituent group based on the first analysis characteristic.

Performing ion mobility spectrometry on the first constituent group can further include, passing the ionized flow containing only the first constituent group to an analytical module of the ion mobility spectrometer, and applying a voltage differential across the analytical module to draw positive ions with in the first constituent group to a negative charge of a first analytical module (e.g., in the first positive drift tube 136) of the ion mobility spectrometer and draw the negative ions within the first constituent group to a positive charge of a second analytical module (e.g., in the first negative drift tube 138) of the ion mobility spectrometer.

Performing ion mobility spectrometry on the first constituent group can further include, separating the ions of first constituent group in space and performing a first time of flight analysis on the ions within the first constituent group to allow selected ions (e.g., those passing through respective shutters 140, 142) within the first constituent group to pass to a fragmenter (e.g., respective fragmenters 144, 146), and fragmenting the selected ions within the first constituent group to further dissociate and generate additional ion types having distinctive mobility characteristics generating a fragmented flow of ions forming the second constituent group.

Performing ion mobility spectrometry on the first constituent group can further include, performing a second time of flight analysis on the fragmented flow of ions within second constituent group to generate a second data set for the second constituent group based on the second analysis characteristic (e.g., as shown in FIG. 4B). The method includes, correlating the second dataset generated for the second constituent group with the first dataset generated for the first constituent group (e.g., as shown in FIG. 4A) and, determining the identity of the chemical composition based on the correlation between the first dataset and the second data set, which can be performed by a computational module.

One way of performing chemical analysis to identify a chemical is single ion mobility spectrometry. In this method, the first step sends an analyte through an ionization region, for a first ion separation. The second step sends the separated ions through a fragmenter to break apart the ions before further separation. Between the first and second steps, a shutter is included to only allow ions with a predetermined peak height enter the fragmenter. Then, only those ions that enter the fragmenter would be analyzed using time of flight to determine the chemical constituents of the analyte, and ultimately determine the chemical identity of the analyte. In order to separate the ions in the first and second separation steps, a voltage gradient is applied to draw the positive ions through the ionization region, and then reverse the voltage gradient to draw the negative ions through the ionization region. However, this technique can require processing the positive and negative ions separately (which can require more energy) and does not provide great resolution.

An improvement on the ion mobility spectrometry described above includes tandem mobility spectrometry, which allows for processing the positive and negative ions at the same time. In a tandem system, the analyte enters the system and is ionized using an ionization source, e.g., a metal. After ionization, the ions are directed to tandem spectrometers, one having a high negative voltage to analyze positive ions and one to having a high positive voltage to analyze negative ions. Within the respective spectrometers, the identity of the chemical constituents can be identified with higher resolution than the single system described above, but without the added benefit of fragmentation.

Accordingly, the system and method disclosed herein, which can employ a tandem differential mobility spectrometer (“DMS”) (e.g, including performing differential mobility spectrometry before and after fragmenting the first constituent group), in conjunction with tandem ion mobility spectrometry (“IMS”) (e.g., including performing ion mobility spectrometry before and after fragmenting the second constituent group), can achieve superior capability over certain non-tandem systems. For example, advantages of the claimed system and method can include, at least, the addition of the DMS ion fragmenter facilitates the second level of information available for tandem mobility spectrometry; the combined DMS and IMS data will provide unprecedented resolution to chemical identification by mobility spectrometry (e.g., aiding in differntiong ions with similar K₀ values; and the simple geometry of the fragmenter overcomes the engineering limitations of the ion fragmenter specifically designed for the IMS/IMS system.

As used herein, resolution is used to refer to a capacity to distinguish ions. The system and method disclosed herein provides for a greater analytical resolving power, to get a more robust set of data (e.g., the combined and correlated data set of FIG. 4A). By fragmenting the ions in both tandem systems, the resulting dissociated ions increases the amount of information available to identify the original sample.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. A method for identifying a chemical composition, comprising:
collecting a chemical sample and introducing the chemical sample to a detection system;
performing, with a differential mobility spectrometer, differential mobility spectrometry on the chemical sample to separate ions within the chemical sample into a first constituent group based on a first analysis characteristic, wherein performing differential mobility spectrometry on the chemical sample further comprises:
filtering the ions within the ionized flow such that only ions having a desired mobility pass to a fragmenter;
fragmenting the filtered sample to further dissociate ions within the filtered sample to generate additional ion types having distinctive mobility characteristics;
performing, with an ion mobility spectrometer, ion mobility spectrometry on the first constituent group to separate ions within the first constituent group into a second constituent group based on a second analysis characteristic; and
determining an identity of the chemical sample based on ions present within the second constituent group.

2. The method of claim 1, further comprising, ionizing the chemical sample using an ionization source to produce an ionized flow prior to performing differential mobility spectrometry on the chemical sample.

3. The method of claim 2, wherein performing differential mobility spectrometry on the chemical sample further comprises:
subjecting the ionized flow to a first radio frequency field to cause ions within the ionized flow to oscillate; and
applying a first voltage differential across the first radio frequency field to cause positive ions within the ionized flow to drift towards a negative charge and negative ions to drift towards a positive charge to separate the positive ions from the negative ions within the ionized flow.

4. The method of claim 3, wherein performing differential mobility spectrometry on the chemical sample further comprises:
filtering the ions within the fragmented ionized flow to generate the first constituent group such that only the first constituent group passes to an ion mobility spectrometer of the detection system,
wherein applying the first voltage differential further includes, progressively modifying the first voltage differential to allow selected ions within the ionized flow and/or the fragmented ionized flow to pass into the ion mobility spectrometer as the first constituent group; and
generating a first data set for the first constituent group based on the first analysis characteristic.

5. The method of claim 3, wherein performing differential mobility spectrometry on the chemical sample further comprises:
applying a second voltage differential across a second radio frequency field to cause positive ions within the fragmented ionized flow to drift towards a negative charge and negative ions to drift towards a positive charge to separate the positive ions from the negative ions within the fragmented ionized flow; and
filtering the ions within the fragmented ionized flow to generate the first constituent group such that only the first constituent group passes to an ion mobility spectrometer.

6. The method of claim 5, wherein applying the first voltage differential and/or applying the second voltage differential further includes, progressively modifying the first voltage differential and/or the second voltage differential to allow selected ions within the ionized flow and/or the fragmented ionized flow to pass into the ion mobility spectrometer as the first constituent group;
and wherein performing differential mobility spectrometry further comprises, generating a first data set for the first constituent group based on the first analysis characteristic.

7. The method of claim 6, wherein performing ion mobility spectrometry on the first constituent group further comprises:
passing the ionized flow containing only the first constituent group to an analytical module of the ion mobility spectrometer; and
applying a voltage differential across the analytical module to draw positive ions with in the first constituent group to a negative charge of a first analytical module of the ion mobility spectrometer and draw the negative ions within the first constituent group to a positive charge of a second analytical module of the ion mobility spectrometer;
separating the ions of first constituent group in space and performing a first time of flight analysis on the ions within the first constituent group to allow selected ions within the first constituent group to pass to a fragmenter; and
fragmenting the selected ions within the first constituent group to further dissociate and generate additional ion types having distinctive mobility characteristics generating a fragmented flow of ions forming the second constituent group.

8. The method of claim 7, wherein performing ion mobility spectrometry on the first constituent group further comprises:
performing a second time of flight analysis on the fragmented flow of ions within second constituent group to generate a second data set for the second constituent group based on the second analysis characteristic;
correlating the second dataset generated for the second constituent group with the first dataset generated for the first constituent group; and
determining the identity of the chemical composition based on the correlation between the first dataset and the second data set.

9. A system, comprising:
a chemical detector including a chemical analyte inlet;
an ionization module having an ionization source therein fluidly connected to the chemical analyte inlet configured to receive the chemical analyte and ionize the chemical analyte to generate an ionized flow; and
an analytical module fluidly connected to the ionization module to receive the ionized flow and configured to determine a chemical identity of the chemical analyte, the analytical module including:
a differential mobility spectrometer fluidly connected to the chemical analyte inlet, wherein the differential mobility spectrometer comprises,
a first set of electrodes including a first positively charged electrode and a first negatively charged electrode configured to separate positive ions from negative ions within the ionized flow and wherein only ions of a predetermined mobility characteristic flow past the first set of electrodes; and
a fragmenter downstream of the first set of electrodes configured to fragment the filtered sample to further dissociate ions within the filtered sample to generate a fragmented ionized flow with additional ion types having distinctive mobility characteristics; and
an ion mobility spectrometer fluidly connected to the differential mobility spectrometer.

10. The system of claim 9, wherein the ionization source is configured to ionize the chemical analyte flowing through ionization region.

11. The system of claim 10, wherein the ionization source includes an electric-field ionizer, a radioactive ionizer, or a photo-ionizer.

12. The system of claim 9, wherein an outlet of the fragmenter is an outlet of the differential mobility spectrometer such that the fragmented ionized flow forms a first constituent group and passes to the ion mobility spectrometer.

13. The system of claim 9, wherein the differential mobility spectrometer comprises a second set of electrodes including a second positively charged electrode and a second negatively charged electrode downstream of the fragmenter configured to separate positive ions from negative ions within the fragmented ionized flow and ions of a predetermined mobility flow past the second set of electrodes forming a first constituent group, wherein the first constituent group passes to the ion mobility spectrometer.

14. The system of claim 13, wherein the differential mobility spectrometer further comprises a computational module configured to generate a first data set for the first constituent group based on a first analysis characteristic.

15. The system of claim 14, wherein the ion mobility spectrometer comprises:
a first positive ion drift tube and a first negative ion drift tube each fluidly connected to an outlet of the differential mobility spectrometer, wherein the first positive ion drift tube is configured to receive positive ions from the first constituent group and the first negative ion drift tube configured to receive negative ions from the first constituent group.

16. The system of claim 15, wherein the ion mobility spectrometer further comprises:
a first shutter at an inlet of the first positive ion drift tube configured to filter the first constituent group entering the first positive ion drift tube based on ion mobility;
a second shutter at an inlet of the first negative ion drift tube configured to filter the first constituent group entering the first negative ion drift tube based on ion mobility,
wherein the first and second shutter provide selected ions from the first constituent group to the first positive ion drift tube and the first negative ion drift tube; and
a first fragmenter disposed at an outlet of the first positive ion drift tube and a second fragmenter disposed at an outlet of the first negative ion drift tube configured to fragment the selected ions from the first constituent group to further dissociate the selected ions from the first constituent group to generate the second constituent group with additional ion types having distinctive mobility characteristics.

17. The system of claim 16, wherein the ion mobility spectrometer further comprises:
a second positive ion drift tube configured to receive fragmented ions from first fragmenter and a second negative ion drift tube configured to receive fragmented ions from the second fragmenter;
a positive ion detector at an end of the second positive ion drift tube configured to draw the positive ions towards the positive ion detector and configured to detect a time of flight of the positive ions of the second constituent group within the second positive ion drift tube;
a negative ion detector at an end of the second negative ion drift tube configured to draw the negative ions towards the negative ion detector and configured to detect a time of flight of the negative ions of the second constituent group within the second negative ion drift tube.

18. The system of claim 17, wherein the analytical module is configured to determine a drift time of the positive ions of the second constituent group within the second positive ion drift tube and a drift time of the negative ions of the second constituent group in the second negative ion drift tube and generate a second data set for the second constituent group based on the second analysis characteristic.

19. The system of claim 18, wherein the analytical module further comprises a computational module configured to correlate the second dataset generated for the second constituent group with the first dataset generated for the first constituent group; and determine the identity of the chemical analyte based on the correlation between the first dataset and the second data set.
